(19) United States
(12) Patent Application Publication
(10) Pub. No.: US 2017/0290380 A1
(43) Pub. Date: Oct. 12, 2017

(54) Slip-on Slip-over Hip Protector

(71) Applicant: Ebony Blackmon-Humphrey, Frisco, TX (US)

(72) Inventor: Ebony Blackmon-Humphrey, Frisco, TX (US)

(21) Appl. No.: 15/095,105

(22) Filed: Apr. 10, 2016

(51) Int. Cl. A41D 13/05; A41D 27/28; A61H 3/00; A41F 9/00

(52) U.S. Cl. CPC A41D 13/0506; A41F 9/002; A41D 27/28; A61H 3/00; A61H 2003/007

(57) ABSTRACT

This invention relates to a multi-function hip protector device (hip protector) designed to slip-on and slip-over existing clothing, to be resistant to incontinence accidents, to reduce the number of hip injuries and dislocations, provide a gait belt member allowing a 3^{rd} person or nurse to assist the wearer in providing gait-sturdy support to those individuals or hospital patients with needed balance correction, provide cushioning of the sacral area and offers protection to the greater trochanters in the event of a fall, add cushion to the pelvis and hips, function as a protectant for bed-ridden people who are unable to adjust their body weight due to a physical debilitation by adding cushion to reduce the shear friction which is a causative agent to bed sores for the elderly with skin integrity issues.

### FIELD OF THE INVENTION

This invention relates to a multi-purpose hip protector to protect and insulate the wearer from hip from injuries, provide 3^{rd} party assistance for balance support, and it is designed with the ability to slip on and slip over existing clothing, designed with the ability to be used in conjunction with incontinence devices, and designed with the ability to reduce bed sores.

### BACKGROUND OF THE INVENTION

At a time when health care costs are escalating, medical research continues to focus on preventative medicine. The study of geriatrics has revealed that elderly individuals have an increased risk of hip fracture disease. Included within the elderly group are several groups at greater risk. Among some of these greater at-risk groups are females over age 50, persons with chronic medical conditions, persons with impaired acuity, persons with osteoporosis, and persons with bodies having low muscle/fat content which is the most frequent cause of hip injuries.

This invention of a slip-on slip-over hip protective device will reduce these foreseeable injuries. First, the new device will reduce the injures because it is convenient to use and the wearer or patient can easily slip on and slip over the device over existing clothing including existing incontinence devices. An embodiment of the device has a hard protective shell which can be easily wiped clean in the case of an incontinence accident. This is a convenient factor for hospital's in which the nurses and medical assistants after cleaning the hip protector can easily reuse the device on multiple patients.

The hip protector contains a gait belt member secured to the hip protector that allows a medical assistant, nurse, or other 3^{rd} party to grip the gait belt to sturdy and help balance a patient as the patient goes from the hospital room to the bathroom or where assistance is needed in providing walking therapy to patients. Many times when patients come out of surgery they have an unsteady gait and the need for balance assistance.

Second, the hip protector has energy absorbing pad protection directed towards the trochanter, the sacral region, and all around hip protection of the patient. One embodiment of the hip protector shell member of the hip protector is made out of the same and similar high-density foam materials used in martial arts sparring equipment. This is especially useful to the protection of bed sores. Upon aging there are various biophysical changes associated with increased age. Of those changes is the thinning of the skin. As the skin thins out, the bony prominent area encompassing the pelvis becomes more evident.

The adipose tissue that once acted as a cushion is diminished. The multi-purpose hip protector adds cushion to both the pelvis and hips. Further the added cushion functions as a protectant for bed ridden people, who are unable to adjust their body weight due to a physical debilitation. It reduces shear friction which is a causative agent to bed sores for the elderly with skin integrity issues.

Many bed-ridden people who are unable to adjust their body weight due to a physical debilitation with compromised skin integrity will have their skin to bed shear friction level reduced by the cushioning effect of the hip encompassing high-density foam materials.

In another embodiment, the hip protector shell member is made out of the harder shell type material similar to that of kendo chest armor sparring equipment type materials. Some of these harder materials include fiberglass or high impact plastic. This embodiment has the advantage of an easy cleaning after an incontinence accident.

Embodiments of the invention will have at least one air flow and heat dissipating perforation member to allow proper air flow between the patients' body, the patients' existing clothing, or the patients' incontinence protection devices and the outside air of the hip protector. This is needed to reduce heat buildup, microbial activities, and fungus growth.

### SUMMARY

The present invention is directed towards a multi-purpose form-fitting hip protector having the advantages of being reusable, advantage of being convenient to the wearer or patient because of its slip-on slip-over design, its advantage in reducing hip injuries because of its all-encompassing protection it provides to the hip, the protection to the trochanter, and the sacral region, its ability to reduce bed sores, its advantage to allow 3rd parties to allow them to help assist the patient or wearer as he or she traverses from place to place, and its ability to be used in conjunction with an underlying incontinence device.

Specific exemplary embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Factors and Aspects of the Invention

It is an aspect of the invention for the hip protector to be reusable and to be available in different sizes.

It is an aspect of the invention for the hip protector to be available in different colors and designs to appeal to different patient audiences to encourage the patient to wear the device and receive the hip protection which the device affords the wearer.

It is an aspect of the invention to have the hip protector easy to dawn on because of its slip-on slip-over form fitting design.

It is an aspect of the invention to provide all-encompassing fall protection to the hip, the trochanter, and the sacral region.

It is an aspect of the invention for the hip protector to reduce bed sores.

It is an aspect of the invention to have the advantage to allow 3rd parties to help assist Ho the patient or wearer as he or she traverses from place to place.

It is an aspect of the invention to have an embodiment of the hip protector to be wiped clean and to be damage free in the event of an incontinence accident.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms, such as second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises a”, “has . . . a”, “includes . . . a”, “contains . . . a” does not, without more constraints, preclude the existence of additional identical elements in the process, method, article, or apparatus that comprises, has, includes, contains the element. Further, the terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%.

The term “coupled” as used herein is defined as connected, although not necessarily directly and not necessarily mechanically. A device or structure that is “configured” in a certain way is configured in at least that way, but may also be configured in ways that are not listed. Also, the term “exemplary” is used as an adjective herein to modify one or more nouns, such as embodiment, system, method, device, and is meant to indicate specifically that the noun is provided as a non-limiting example.

### BRIEF DESCRIPTION OF THE DRAWING FIGURES

FIG. 1A is a front side view of one of the embodiments of the present invention;

FIG. 1B is a back side view of one of the embodiments of the present invention;

FIG. 2 is an illustration of a nurse assisting a patient wearing an embodiment of the present invention.

FIG. 3 is an illustration of front angled view of a patient wearing an embodiment of the present invention.

### REFERENCE LISTING OF THE NUMBERED ELEMENTS

100 hip protector shell member

200 gait belt buckle-fastener

300 gait belt member

400 energy-absorbent pad members

500 air flow and heat dissipating perforation member

600 mesh-like member leg opening

Definitions

In the following description, the term “the sacral region” as used herein, describes the sacral region (sacrum) is at the bottom of the spine and lies between the fifth segment of the lumbar spine (L5) and the coccyx (tailbone).

In the following description, the term “trochanter” as used herein, describes an anatomical part of the femur connecting to the hip bone.

In the following description, the term “gait belt member” as used herein, describes a belt fastened, attached, and secured to the hip protector device that allows room for an assistant or nurse assistant's hands to grip the belt to sturdy the wearer or patient balance as the wearer or patient traverses to and fro.

In the following description, the term “hip protector shell member” as used herein, describes the shell guard component of the hip protector upon to which the other hip protector members attach and that is made out today's commercially available high-density foam materials normally found in martial arts sparring equipment or the hard shell type material that comprises kendo sparring equipment chest armor type material such as fiberglass or high impact plastic.

In the following description, the term “hip protector” as used herein, describes a slip-on slip-over hip protector comprising: a hip protector shell member made out of today's commercially available high-density foam materials normally found in martial arts sparring equipment or the hard shell type material that comprises kendo sparring equipment chest armor type material; a gait belt member fastened and secured to said hip protector shell member; the said gait belt member to securely encompass the top portion of the hip protector and being sufficiently study for a 3^{rd} party to be able to grasp, maneuver, manipulate, hold, assist, and guide the weight of at least a 400 lb person walking who is wearing the hip protector; a gait belt buckle-fastener attached to both ends of the said gait belt member; a plurality of energy-absorbent pad members attached and fastened to the said hip protector shell member; at least one air flow and heat dissipating perforation member attached and fastened to the said hip protector shell member; two mesh-like member leg openings attached and fastened to the said hip protector shell member.

The singular terms “a”, “an”, and “the” include plural referents unless the context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” All publications, patent applications, patents, and other references mentioned herein are incorporated by reference in their entirety for all purposes. In case of conflict, the present specification, including explanations of terms, will control. In addition, the materials, methods, and examples are illustrative only and not intended to be limiting.

Figures

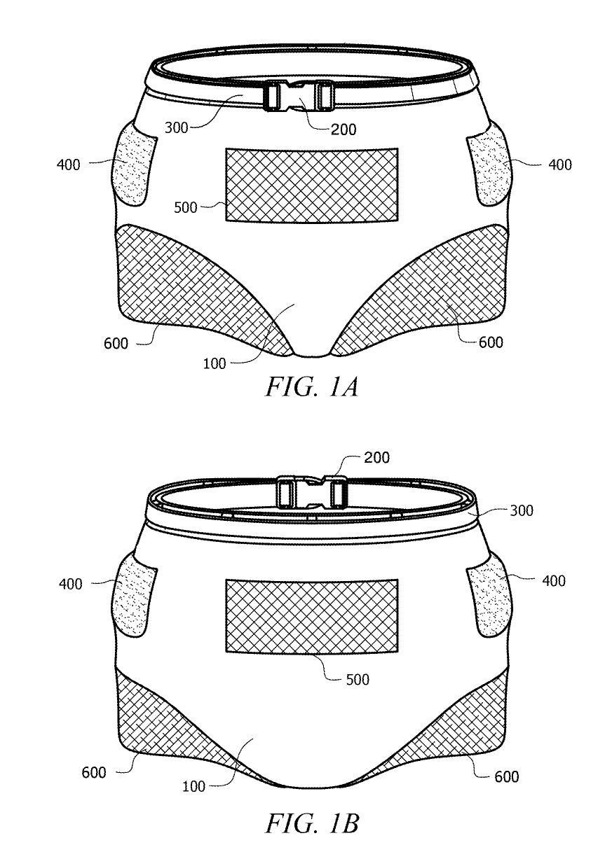

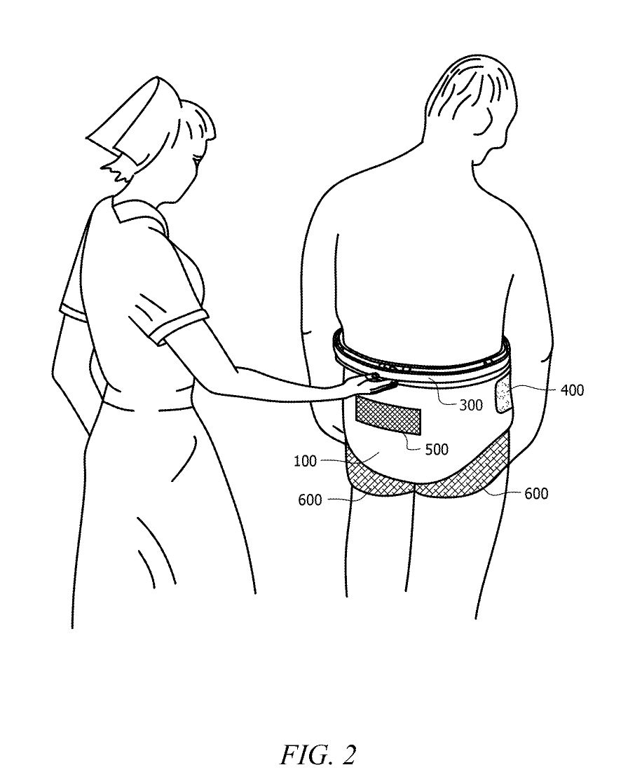

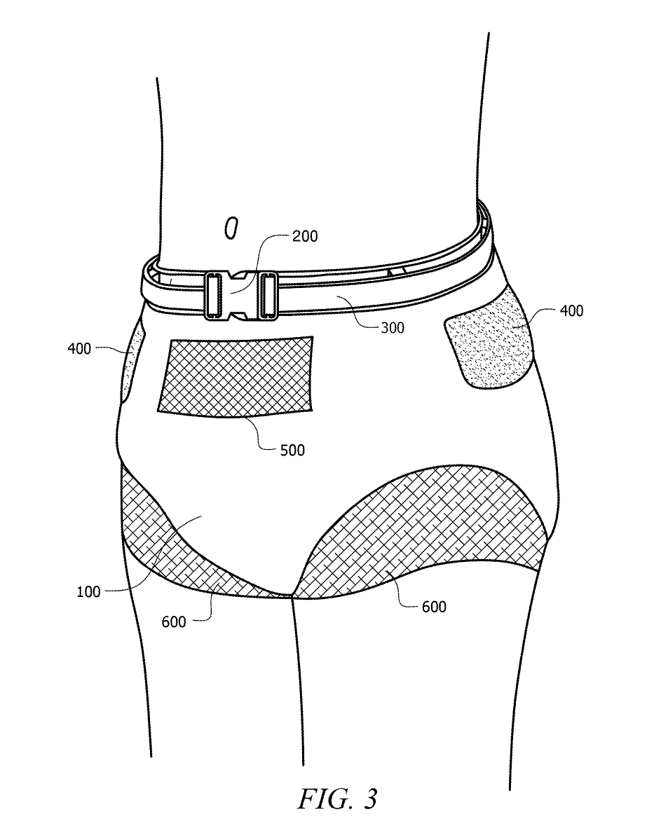

Referring generally to FIGS. 1A, 1B, 2, and 3, these figures illustrate embodiments according to the present invention for a slip-on slip-over hip protector (hip protector.)

Referring to FIGS. 1A, 1B, 2, and 3. The main body component of the said hip protector is the hip protector shell member 100. The hip protector shell member describes the shell guard component of the hip protector upon to which the other hip protector members attach and that is made out today's commercially available high-density foam materials normally found in martial arts sparring equipment or the hard shell type material that comprises kendo sparring equipment chest armor type material. The figures additionally illustrate an embodiment with a hip protector having the required gait belt member 300 which is fastened and secured to the said hip protector shell member 100, the gait belt member 300 has attached to both of its ends a gait belt buckle-fastener 200 for fastening on the slip-on slip-over hip protector invention. Further, the figure illustrates a plurality of energy-absorbent pad member's 400 that are attached and fastened to the said hip protector shell member 100. Mesh-like member leg opening 600 are shown attached to the said hip protector shell member 100.

It should be understood that the drawings and detailed description herein are to be regarded in an illustrative rather than a restrictive manner, and are not intended to be limiting to the particular forms and examples disclosed. Accordingly, it is intended that this disclosure encompass any further modifications, changes, rearrangements, substitutions, alternatives, design choices, and embodiments as would be appreciated by those of ordinary skill in the art having benefit of this disclosure, and falling within the scope of the following claims.

What is claimed is:

1. A slip-on slip-over hip protector comprising:
a hip protector shell member made out of today's commercially available high-density foam materials; a gait belt member; a means for fastening the said gait belt member to the said hip protector shell member that leaves a gap between the said gait belt member and the said hip protector shell member sufficient enough to insert fingers of a hand; the said gait belt member to have a means to secure the said hip protector shell member to the wearer of the said slip-on slip-over hip protector with a gait belt buckle-fastener; the said gait belt buckle-fastener attached to both ends of the said gait belt member; a plurality of energy-absorbent pad members; a means for attaching the said energy-absorbent pad members to the said hip protector shell member; at least one air flow and heat dissipating perforation member; a means for the at least one air flow and heat dissipating perforation member to be fastened to the hip protector shell member.

2. A slip-on slip-over hip protector according to claim 1 where in the slip-on slip-over hip protector comprises: at least one adjustable mesh-like member leg opening; a means for fastening the said at least one mesh-like member leg opening to the said hip protector shell member.

3. A slip-on slip-over hip protector comprising:
a hip protector shell member made out of today's commercially available hard and water resistant materials such as fiberglass or high impact plastic; a gait belt member; a means for fastening the said gait belt member to the said hip protector shell member that leaves a gap between the said gait belt member and the said hip protector shell member sufficient enough to insert fingers of a hand; the said gait belt member to have a means to secure the said hip protector shell member to the wearer of the said slip-on slip-over hip protector with a gait belt buckle-fastener;
the said gait belt buckle-fastener attached to both ends of the said gait belt member; a plurality of energy-absorbent pad members; a means for attaching the said energy-absorbent pad members to the said hip protector shell member; at least one air flow and heat dissipating perforation member; a means for the at least one air flow and heat dissipating perforation member to be fastened to the hip protector shell member.

4. A slip-on slip-over hip protector according to claim 3 where in the slip-on slip-over hip protector comprises: at least one mesh-like member leg opening; a means for fastening the said at least one adjustable mesh-like member leg opening to the said hip protector shell member.

5. A method for using a slip-on slip-over hip protector comprising the steps of:
I. Providing a slip-on slip-over hip protector comprising a hip protector shell member made out of today's commercially available high-density foam materials; a gait belt member; a means for fastening the said gait belt member to the said hip protector shell member that leaves a gap between the said gait belt member and the said hip protector shell member sufficient enough to insert fingers of a hand; the said gait belt member to have a means to secure the said hip protector shell member to the wearer of the said slip-on slip-over hip protector with a gait belt buckle-fastener; the said gait belt buckle-fastener attached to both ends of the said gait belt member; a plurality of energy-absorbent pad members; a means for attaching the said energy-absorbent pad members to the said hip protector shell member; at least one air flow and heat dissipating perforation member; a means for the at least one air flow and heat dissipating perforation member to be fastened to the hip protector shell member;
II. The patient or wearer dawns on the slip-on slip-over hip protector;
III. A nurse or 3^{rd} party assistance will grab hold of the gait belt member of the hip protector and steady the wearer's balance as the wearer walks about;
IV. Upon an incontinence accident the wearer or 3^{rd} party wipes clean the inside of the hip protector;
V. The wearer or patient sleeps in the hip protector to reduce the occurrence of bed sores.
